(19) United States
(12) Patent Application Publication
(10) Pub. No.: US 2015/0298516 A1
(43) Pub. Date: Oct. 22, 2015

(54) PUMP HEAD AND VALVE STEM ASSEMBLY

(71) Applicant: Trek Bicycle Corporation, Waterloo, WI (US)

(72) Inventors: Neil Purisch, Lake Mills, WI (US); Brian Hanold, Stoughton, WI (US)

(73) Assignee: Trek Bicycle Corp., Waterloo, WI (US)

(21) Appl. No.: 14/625,627

(22) Filed: Feb. 18, 2015

Related U.S. Application Data
(60) Provisional application No. 61/941,008, filed on Feb. 18, 2014.

(51) Int. Cl. B60C 29/00; B60C 29/04

(52) U.S. Cl. CPC B60C 29/005; B60C 29/04

(57) ABSTRACT

An apparatus comprising a valve stem. The valve stem assembly can be part of a rim or inner tube. The valve stem assembly can include a valve core body and a valve stem. The valve core body can be sealed to the valve stem by a valve core body seal. The valve core body can include a spring-loaded pintle that can be configured to open and close when a pump head is attached. The valve core body can include a groove configured to retain a locking device of a pump head. The sides of the groove can be eased, for example, chamfered or filleted. The tip of the valve core body can be eased, for example, chamfered or filleted.

### CROSS-REFERENCE TO RELATED PATENT APPLICATIONS

This application claims the benefit of U.S. Provisional Application No. 61/941,008, titled Pump Head and Valve Stem Assembly, filed Feb. 18, 2014 which is incorporated herein by reference in its entirety.

### BACKGROUND

The present invention relates generally to the field of bicycle pumps and more particularly to the field of bicycle pump heads and valve stems.

### SUMMARY

One illustrative embodiment is related to an apparatus including a valve stem. The valve stem assembly can be part of a rim or inner tube. The valve stem assembly can include a valve core body and a valve stem. The valve core body can be sealed to the valve stem by a valve core body seal. The valve core body can include a spring-loaded pintle that can be configured to open and close when a pump head is attached. The valve core body can include a groove configured to retain a locking device of a pump head. The sides of the groove can be eased, for example, chamfered or filleted. The tip of the valve core body can be eased, for example, chamfered or filleted.

Another illustrative embodiment is related to a valve core body. The valve core body can include a valve core body seal for sealing to a valve stem. The valve core body can include a spring-loaded pintle that can be configured to open and close when a pump head is attached. The valve core body can include a groove configured to retain a locking device of a pump head. The sides of the groove can be eased, for example, chamfered or filleted. The tip of the valve core body can be eased, for example, chamfered or filleted.

Another illustrative embodiment is related to a pump head for attaching to a valve core body. The valve core body can include a valve core body seal for sealing to a valve stem. The valve core body can include a spring-loaded pintle that can be configured to open and close when a pump head is attached. The valve core body can include a groove configured to retain a locking device of a pump head. The sides of the groove can be eased, for example, chamfered or filleted. The tip of the valve core body can be eased, for example, chamfered or filleted.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a side view of a bicycle and pump in accordance with an illustrative embodiment.

FIG. 2 is a perspective view of the front wheel assembly of FIG. 1 in accordance with an illustrative embodiment.

FIG. 3 is a close up view of the front wheel assembly of FIG. 2 in accordance with an illustrative embodiment.

FIG. 4 is a perspective view of the pump of FIG. 1 in accordance with an illustrative embodiment.

FIG. 5 is a close up view of the pump of FIG. 4 in accordance with an illustrative embodiment.

FIG. 6 is a side view of a valve core body and section view of a valve stem of a valve stem assembly in accordance with an illustrative embodiment.

FIG. 7 is a section view of the valve core body of FIG. 6 in accordance with an illustrative embodiment.

FIG. 8 is an exploded view of the valve core body of FIG. 6 in accordance with an illustrative embodiment.

FIG. 9 is a side view of a pump head assembly in accordance with an illustrative embodiment.

FIG. 10 is a section view of the pump head assembly of FIG. 9 in accordance with an illustrative embodiment.

FIG. 11 is an exploded view of the pump head assembly of FIG. 9 in accordance with an illustrative embodiment.

FIG. 12 is a side view of the pump head assembly of FIG. 9 connected to the valve core body of FIG. 6 in accordance with an illustrative embodiment.

FIG. 13 is a perspective view of the pump head assembly connected to the valve core body of FIG. 12 in accordance with an illustrative embodiment.

FIG. 14 is a side section view of the pump head assembly connected to the valve core body of FIG. 12 in accordance with an illustrative embodiment.

FIG. 15 is a radial section view of the pump head assembly connected to the valve core body of FIG. 12 in accordance with an illustrative embodiment.

FIG. 16 is a perspective section view of the pump head assembly connected to the valve core body of FIG. 12 in accordance with an illustrative embodiment.

FIG. 17 is a side view of the pump head assembly of FIG. 9 disconnected from the valve core body of FIG. 6 in accordance with an illustrative embodiment.

FIG. 18 is a side section view of the pump head assembly disconnected from the valve core body of FIG. 17 in accordance with an illustrative embodiment.

### DETAILED DESCRIPTION OF THE ILLUSTRATIVE EMBODIMENTS

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood, that the aspects of the present disclosure, as generally described herein, and illustrated in the figures, can be arranged, substituted, combined, and designed in a wide variety of different configurations, all of which are explicitly contemplated and make part of this disclosure.

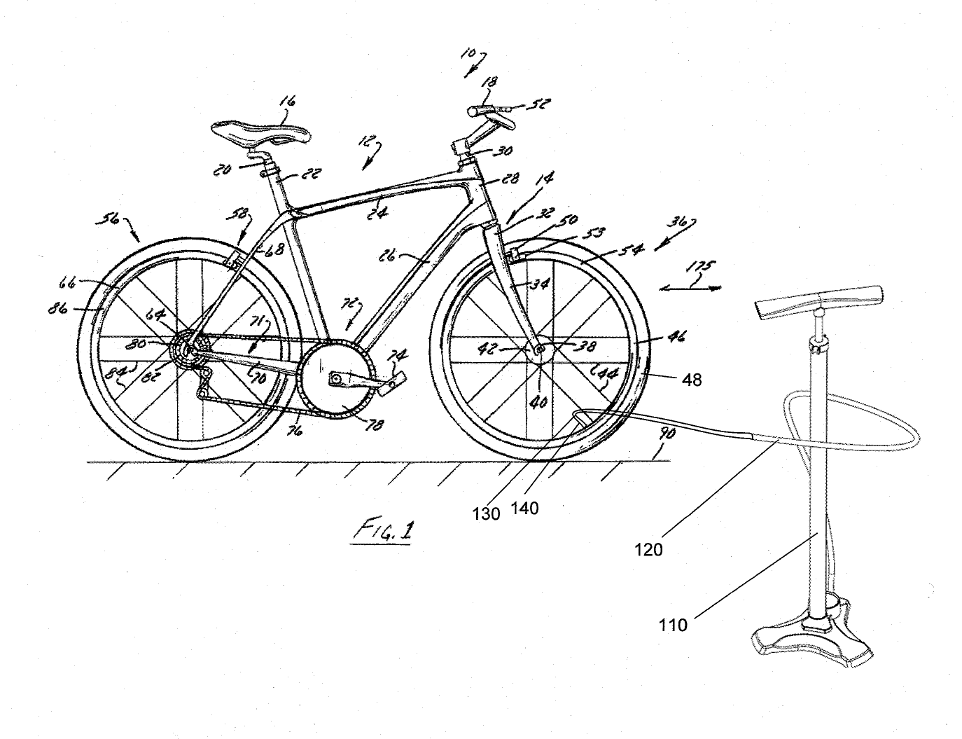

The present disclosure is directed to a quick attach and quick release bicycle pump. Referring to FIG. 1, a side view of a bicycle 12 and pump 110 in accordance with an illustrative embodiment is shown. The bicycle 12 can have a frame assembly 12. The bicycle 12 can include a seat 16 and handlebars 18 that are attached to frame assembly 12. A seat post 20 can be connected to seat 16 and can slidably engage a seat tube 22 of the frame assembly 12. A top tube 24 and a down tube 26 can extend forwardly from the seat tube 22 to a head tube 28 of the frame 12. Handlebars 18 can be connected to a stem or steer tube 12 that can pass through the head tube 28 and can be connected or integrally formed with a fork crown 32. The handlebar 18 can include a stem that is constructed to slidably engage an interior cavity of the steer tube 30. One or more of the structures of bicycle 12 and frame assembly 12 can be constructed from similar materials, a variety of different materials, and various combinations thereof The frame assembly 12 and seat tube 22 can be formed of metal-type materials, such as steel, aluminum-type materials, fiber reinforced plastic, carbon fiber materials, and/or materials that are sufficiently formable and robust enough to support a rider of bicycle 30.

A fork assembly 14 can include a pair of fork blades or fork legs 34 that can extend from generally opposite ends of a fork crown 32 and can be constructed to support a front wheel assembly 36 at an end thereof or a dropout 38. The dropouts 38 can engage generally opposite sides of an axle 40 constructed to engage a hub 42 of the front wheel assembly 36. The hub 42 can be, for example, a freehub or a freewheel hub. A number of spokes 44 can extend from hub 42 to a rim 46 of the front wheel assembly 36. A tire 48 can be engaged with rim 46 such that rotation of the hub 42 and the rim 46, relative to the fork legs 34, rotates the tire 48. The rim 46 can be covered with a brake material, in part or in its entirety, to enhance braking characteristics.

The bicycle 12 can include a front brake assembly 50 having an actuator 52 attached to handlebars 18 and a pair of brake pads 53 positioned on generally opposite sides of front wheel assembly 36. The brake pads 53 can be constructed to engage a brake wall 54 of the rim 46 thereby providing a stopping or slowing force to front wheel assembly 36. A rear wheel assembly 56 can include a brake assembly 58 similar to the front wheel brake assembly 50. Brake assemblies 50, 58 can be any brake configuration such as, but not limited to, a rim brake or disk brake assembly wherein a rotor and a caliper are positioned proximate one or more of front wheel axle 40 or a rear axle 64, respectively. The rotor can be covered with a brake material, in part or in its entirety, to enhance braking characteristics. A rear wheel 66 can be positioned generally concentrically about rear axle 64.

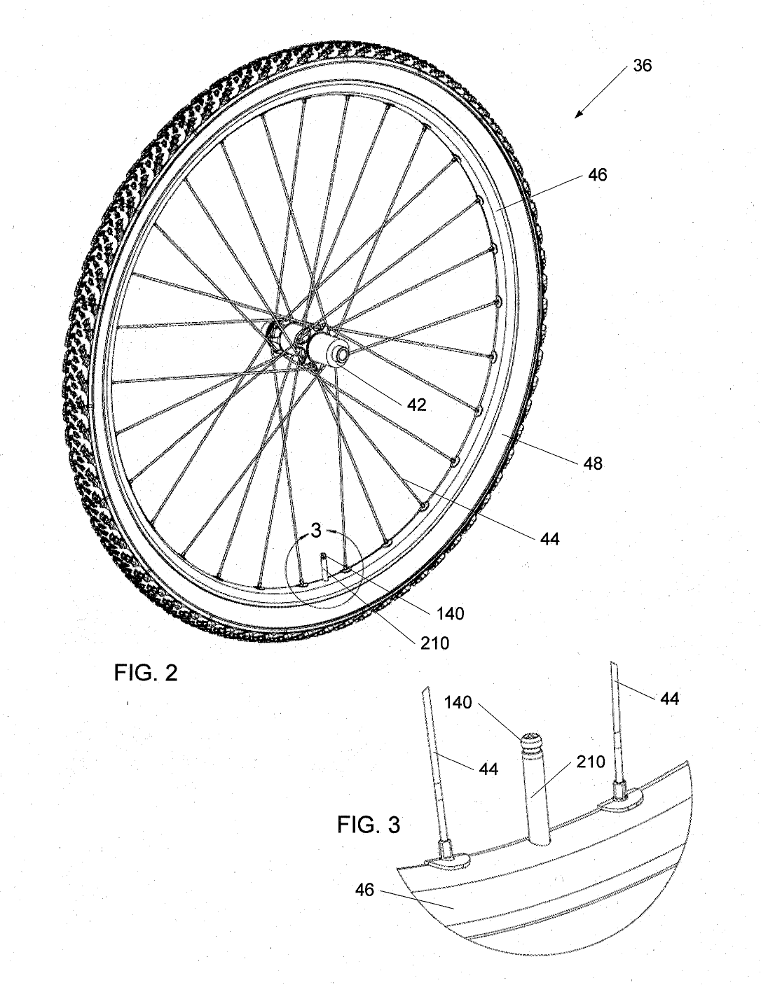

A pair of seat stays 68 (FIG. 2) and a pair of chain stays 70, 71 can extend, rearward relative to the seat tube 22 and the offset rear axle 64 from a crankset 72. The crank set 72 can include a set of pedals 74 that can be operationally connected to a flexible drive member such as a chain 76 via one or more variable diameter chain gears or a chain ring or sprocket 78. Rotation of chain 76 can communicate a drive force to a gear cluster 80 positioned proximate rear axle 64. The gear cluster 80 can be generally concentrically orientated with respect to the rear axle 64 and can include a number of variable diameter gears.

The gear cluster 80 can be operationally connected to a hub 82 of the rear wheel 66. The hub 82 can be, for example, a freehub or a freewheel hub. A number of spokes 84 can extend radially between the hub 82 and a rim 86 of rear wheel 66 of rear wheel assembly 56. The rim 86 can be covered with a brake material. Rider operation of the pedals 74 can drive the chain 76 thereby driving the rear wheel 66 which in turn propels the bicycle 30. The fork assembly 14 can be constructed to support a forward end 88 of the bicycle 12 above a ground surface 90. The handlebar 18 can be connected to the frame 12 and the fork assembly 14 such that operator manipulation of the handlebar 18 can be communicated to the fork assembly 14 to facilitate rotation of the front wheel assembly 36 relative to the frame assembly 12 along a longitudinal axis, indicated by arrow 175, of the bicycle 30. Manipulation of the handlebar 18 can steer the bicycle 12 during riding.

The construction of bicycle 12 depicted in FIG. 1 is merely exemplary of a number of bicycle configurations. Whereas bicycle 12 is shown as what is commonly understood as a street or road bike, the present disclosure is applicable to a number of bicycle configurations including those bicycles with more aggression suspension systems commonly found in off-road or mountain bike frame configurations, and/or hybrids, cross-over or multi-purpose bicycle frame configurations.

The pump 110 can include a hose 120 with a pump head assembly 130. The pump head assembly 130 can be removably coupled, for example, to a valve stem assembly 140 of the rim 46 of the front wheel assembly 36. The pump 110 can be used to inflate the front wheel assembly 36.

Referring to FIG. 2, a perspective view of the front wheel assembly 36 of FIG. 1 in accordance with an illustrative embodiment is shown. Referring to FIG. 3, a close up view of the front wheel assembly 36 of FIG. 2 in accordance with an illustrative embodiment is shown. As described above the front wheel assembly 36 can include the hub 42, the rim 46, and the tire 48. The hub 42 can be connected to rim 46 by spokes 44. The valve stem assembly 140 can include a stem 210 that can be connected to the rim 46 or a tube (not shown) inserted into tire 48.

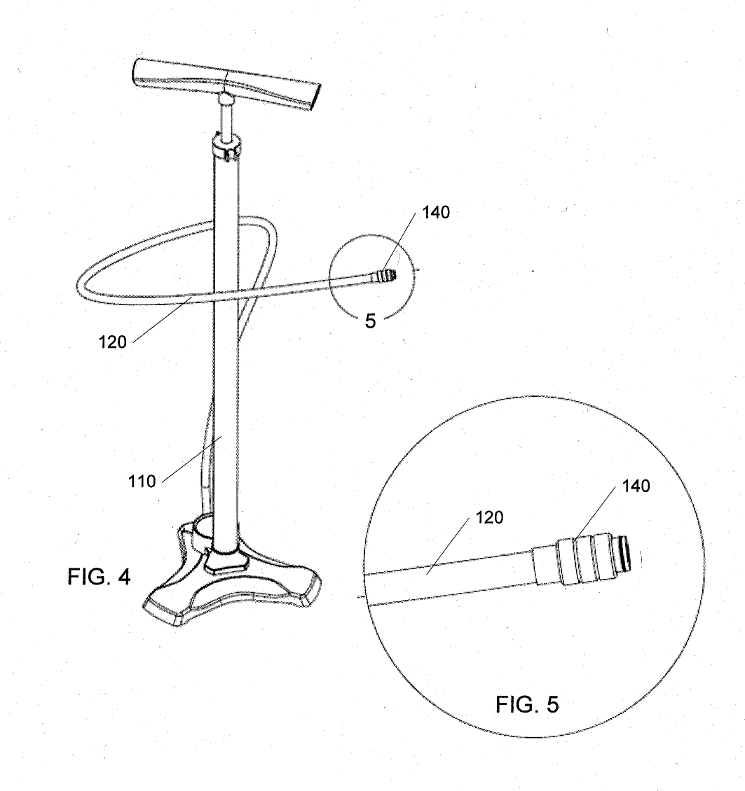

Referring to FIG. 4, a perspective view of the pump 110 of FIG. 1 in accordance with an illustrative embodiment is shown. Referring to FIG. 5, a close up view of the pump 110 of FIG. 4 in accordance with an illustrative embodiment is shown. The pump 110 can include pump head assembly 130 for fluidly connecting the pump 110 to a valve stem assembly of a wheel assembly.

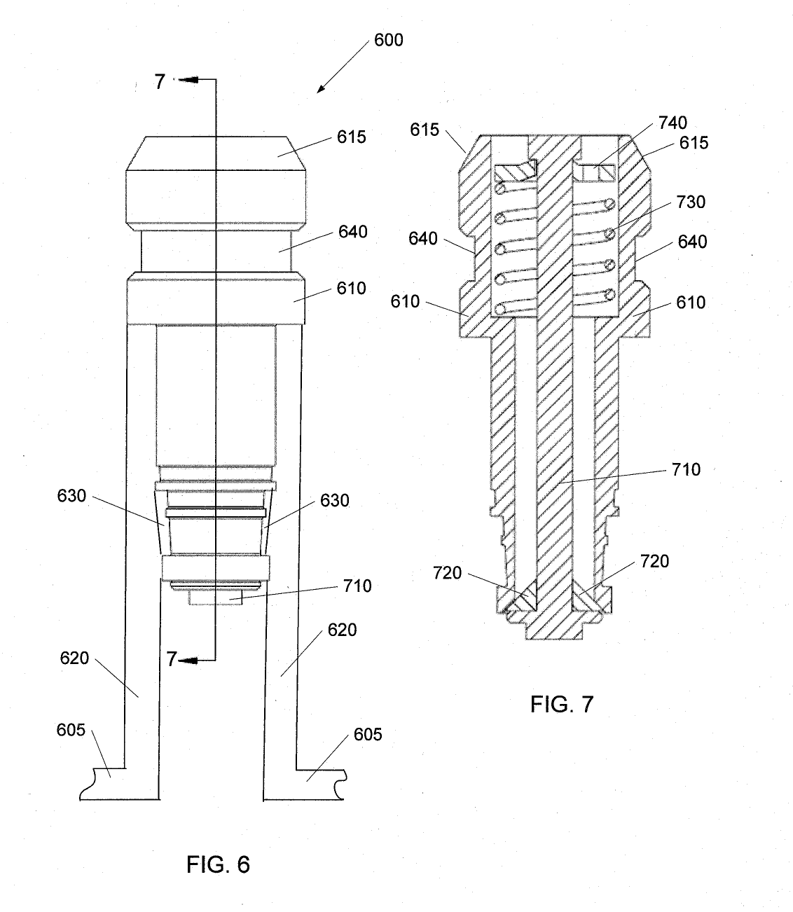

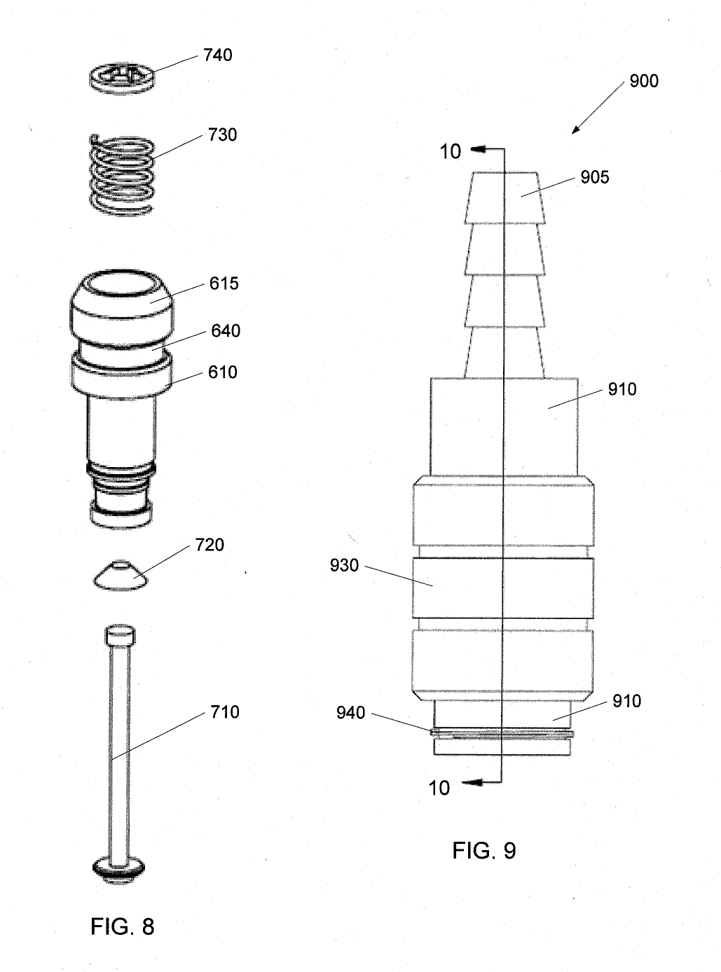

Referring to FIG. 6, a side view of a valve core body 610 and section view of a valve stem 620 of a valve stem assembly 600 in accordance with an illustrative embodiment is shown. Referring to FIG. 7, a section view of the valve core body 610 of FIG. 6 in accordance with an illustrative embodiment is shown. Referring to FIG. 8, an exploded view of the valve core body 610 of FIG. 6 in accordance with an illustrative embodiment is shown. The valve stem assembly 600 can be part of a rim or inner tube 605. In one embodiment, the valve core body 610 can be inserted into any Presta-type valve stem. In another embodiment, the valve core body 610 can be inserted into any Schrader-type valve stem. In another embodiment, the valve core body 610 can be integral to a valve stem. In another embodiment, the valve core body 610 can be an adapter affixed to a valve stem.

The valve stem assembly 600 can include a valve core body 610 and a valve stem 620. The valve core body 610 can be sealed to the valve stem 620 by a valve core body seal 630. The valve core body 610 can include a spring-loaded pintle 710 that can be configured to open and close when a pump head is attached. The valve core body 610 can include a groove 640 configured to retain a locking device of a pump head. The sides of the groove can 640 be eased, for example, chamfered or filleted. A tip 615 of the valve core body can be eased, for example, chamfered or filleted.

The pintle 710 can include a pintle seal 720. The pintle seal 720 can be biased against a seat of the valve core body 610 by an assembly spring 730 that is captured between the valve core body 610 and a retaining clip 740 that is coupled to the pintle 710.

Advantageously, a standard air-compressor air filling chuck, a Schrader-type pump head or a Presta-type pump head can still be used with the valve core body 610.

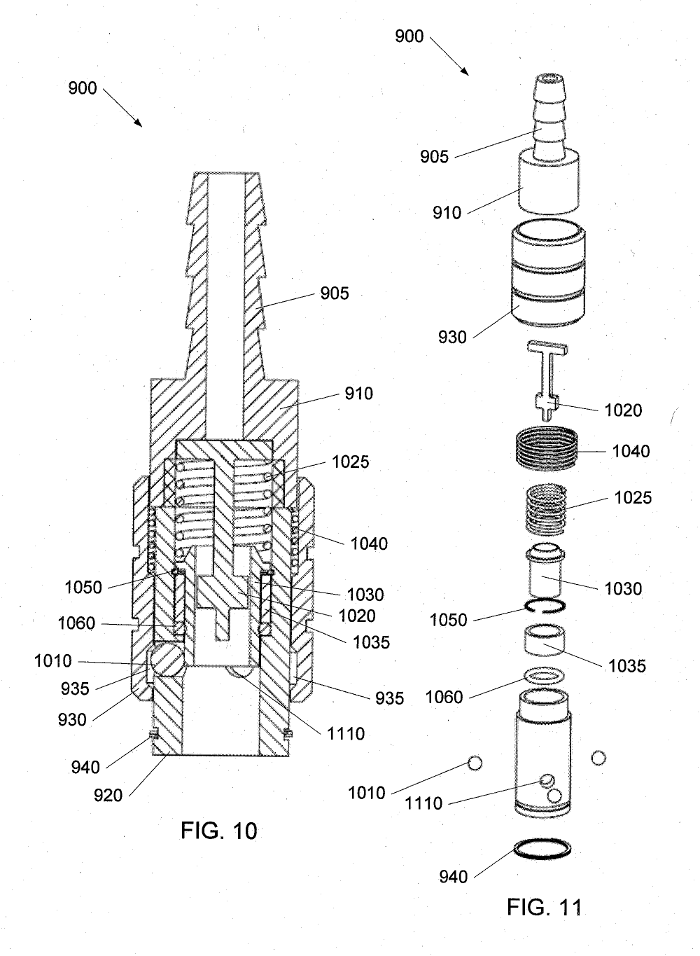

Referring to FIG. 9, a side view of a pump head assembly 900 in accordance with an illustrative embodiment is shown. Referring to FIG. 10, a section view of the pump head assembly 900 of FIG. 9 in accordance with an illustrative embodiment is shown. Referring to FIG. 11, an exploded view of the pump head assembly 900 of FIG. 9 in accordance with an illustrative embodiment is shown. The pump head assembly 900 can include an upper body 910 and a lower body 920. The upper body 910 can be attached to a hose by, for example, barbs 905. The lower body 920 can include holes 1110 for holding balls 1010. A pintle actuator 1020 can be captured between the upper body 910 and the lower body 920. A preload bushing 1030 can be spring loaded by spring 1025. The preload bushing 1030 can make it easier to remove the pump head assembly 900 from a valve body by predisposing the pump head assembly 900 to push away. The preload bushing 1030 can be held into the lower body 920 by retainer clip 1050. A bushing 1035 can guide the preload bushing 1030. An o-ring 1060 can seal the pump head assembly 900 to a valve stem assembly. The spring 1025 can be captured between the pintle actuator 1020 and the preload bushing 1030. The pintle actuator 1020 can press against the pintle 710 when the pump head assembly 900 is coupled to the valve core body 610.

An actuator sleeve 930 can be located around the lower body 920 and at least partially cover the holes 1110. The actuator sleeve 930 can include a ball groove 935. The actuator sleeve 930 can be spring loaded against the upper body 910 by spring 1040. The actuator sleeve 930 can be retained on the lower body 920 by retainer clip 940. In a first position of the actuator sleeve 930, the balls 1010 are held toward the center of the lower body 920 by the actuator sleeve 930. In a second position of the actuator sleeve 930, the ball groove 935 aligns with the holes 1110 and the balls 1010 are free to move away from the center of the lower body 920 and at least partially into the ball groove 935 of the actuator sleeve 930.

Advantageously, the pump head assembly 900 can quickly and easily be attached to and removed from valve stem assembly.

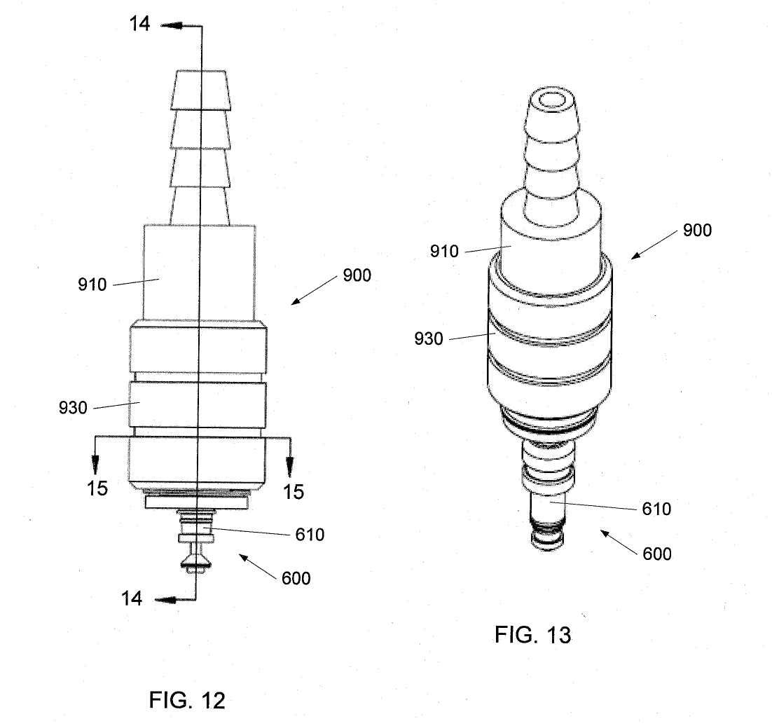

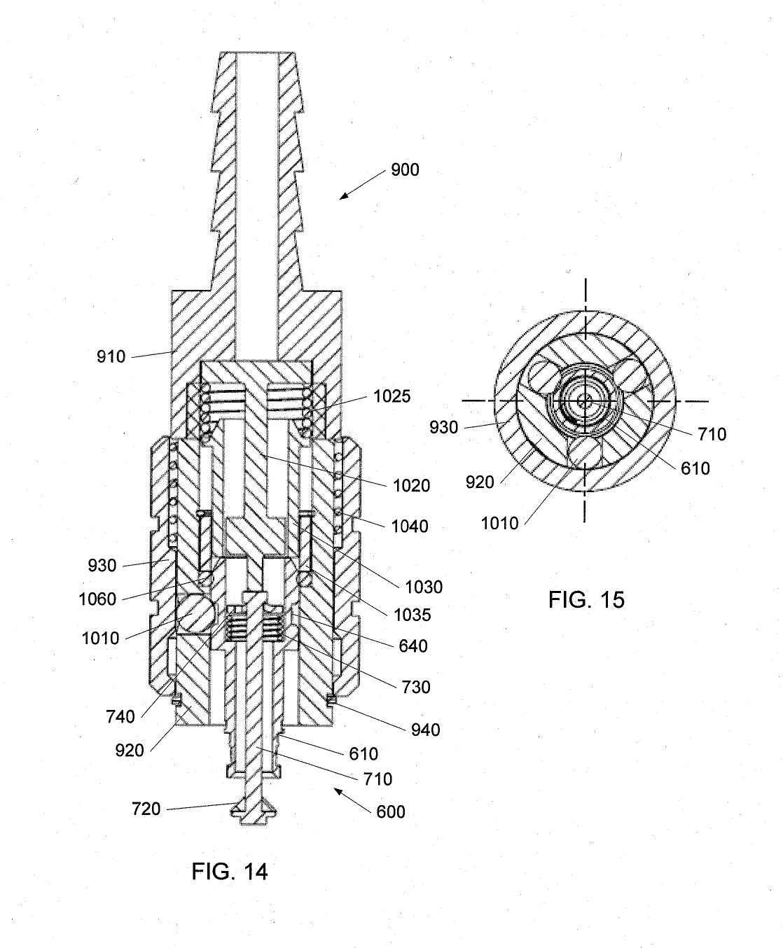

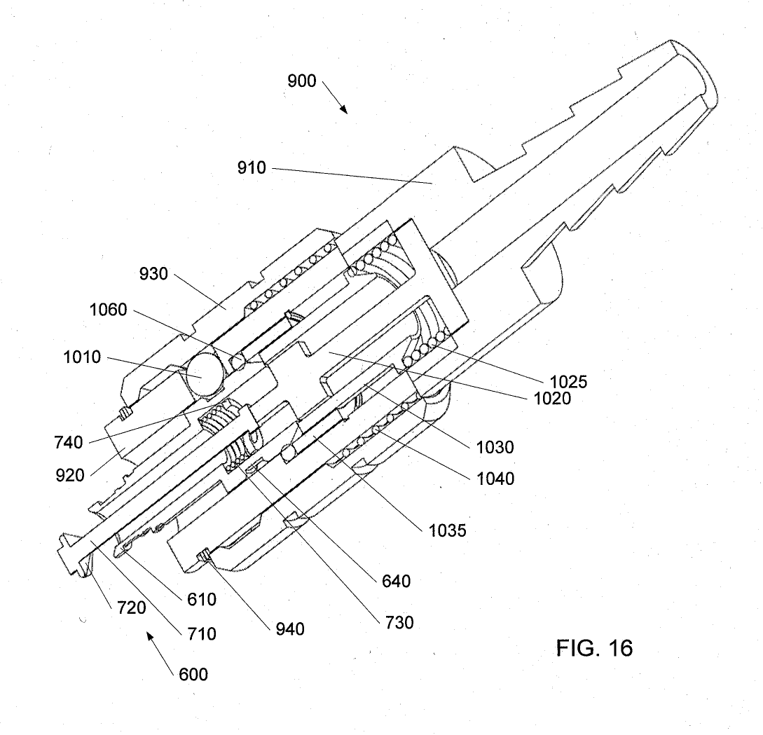

Referring to FIG. 12, a side view of the pump head assembly 900 of FIG. 9 connected to the valve core body 610 of FIG. 6 in accordance with an illustrative embodiment is shown. Referring to FIG. 13, a perspective view of the pump head assembly 900 connected to the valve core body 610 of FIG. 12 in accordance with an illustrative embodiment is shown. Referring to FIG. 14, a side section view of the pump head assembly 900 connected to the valve core body 610 of FIG. 12 in accordance with an illustrative embodiment is shown. Referring to FIG. 15, a radial section view of the pump head assembly 900 connected to the valve core body 610 of FIG. 12 in accordance with an illustrative embodiment is shown. Referring to FIG. 16, a perspective section view of the pump head assembly 900 connected to the valve core body 610 of FIG. 12 in accordance with an illustrative embodiment is shown.

The balls 1010 of the pump head assembly 900 are seated in the groove 640 of the valve core body 610, thereby securing the pump head assembly 900 to the valve core body 610. When actuator sleeve 930 of the pump head assembly 900 is pulled back, the balls 1010 of the pump head assembly 900 can move out of the way of the valve core body 610 and the pump head assembly 900 can be pulled off of the valve core body 610.

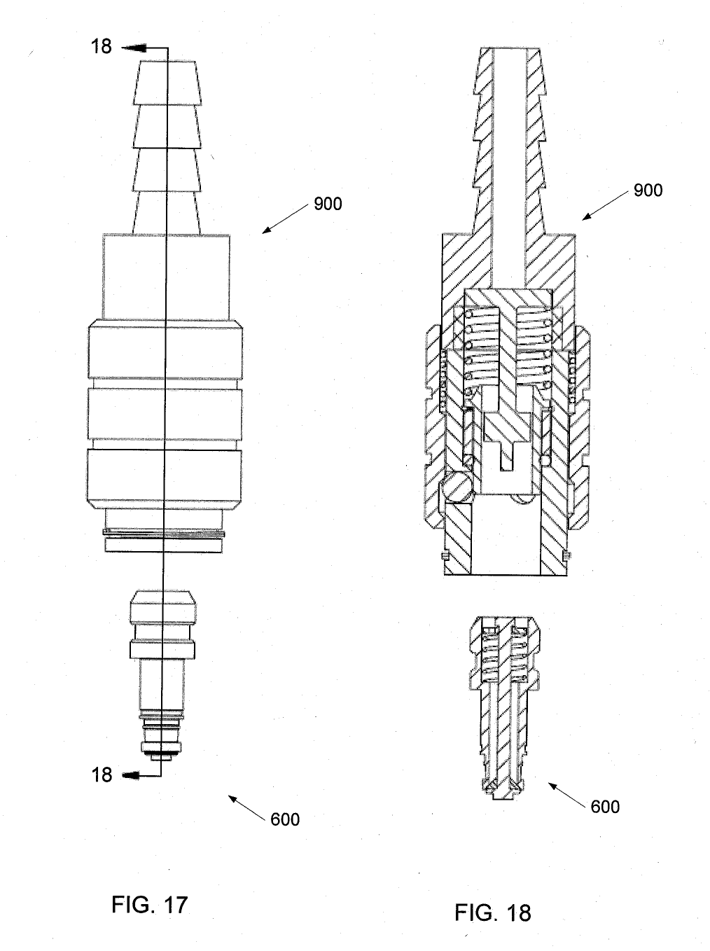

In contrast, referring to FIG. 17, a side view of the pump head assembly 900 of FIG. 9 disconnected from the valve core body 610 of FIG. 6 in accordance with an illustrative embodiment is shown. Referring to FIG. 18, a side section view of the pump head assembly 900 disconnected from the valve core body 610 of FIG. 17 in accordance with an illustrative embodiment is shown.

One or more flow diagrams may have been used herein. The use of flow diagrams is not meant to be limiting with respect to the order of operations performed. The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence, of such recitation no such intent is present For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A kit, comprising:
a valve core body of a bicycle tire tube including:
a spring-loaded pintle that is configured to open when a pump head is attached;
at least one of a chamfered or filleted tip; and
a groove configured to retain a locking device of the pump head;
the pump head including:
a lower body including holes and a chamber for receiving at least a portion of the valve core body;
balls located in the holes; and
an actuator sleeve for selectively trapping the balls against the groove and releasing the balls from the groove.

2. The kit of claim 1, wherein the pintle includes a seal.

3. The kit of claim 1, wherein the pump head further includes a head pintle for actuating the pintle of the valve core body.

4. The kit of claim 1, wherein the pump head further includes a preload bushing configured to preload the pump head from the valve core body.
